(19) United States
(12) Patent Application Publication
(10) Pub. No.: US 2010/0211819 A1
(43) Pub. Date: Aug. 19, 2010

(54) METHOD AND A DEVICE FOR CONTROLLING A MEMORY ACCESS IN A COMPUTER SYSTEM HAVING AT LEAST TWO EXECUTION UNITS

(76) Inventors: Reinhard Weiberle, Vaihingen/Enz (DE); Bernd Mueller, Leonberg-Silberbers (DE); Eberhard Boehl, Reutlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 12/063,211

(22) PCT Filed: Jul. 26, 2006
(86) PCT No.: PCT/EP06/64700

§ 371 Date: Apr. 29, 2010

(30) Foreign Application Priority Data
Aug. 8, 2005 (DE) 102005037247.3

(51) Int. Cl. G06F 11/00; G06F 12/00; G06F 11/07

(52) U.S. Cl. 714/5; 711/154; 711/141; 711/E12.001; 711/E12.017; 714/E11.021

(57) ABSTRACT

A method and device for controlling memory access in a computer system having at least two execution units, a buffer, in particular a cache being provided for each execution unit, and furthermore a switchover device and a comparison device being provided, the system switching between a performance mode and a compare mode, wherein in the performance mode each execution unit accesses the buffer assigned to it and in the compare mode both execution units access one buffer.

### FIELD OF THE INVENTION

The present invention relates a method and a device for comparing output data of at least two execution units of a microprocessor.

### BACKGROUND INFORMATION

Transient errors, triggered by alpha particles or cosmic radiation, are an increasing problem for integrated circuits. Due to declining structure widths, decreasing voltages and higher clock frequencies, there is an increased probability that a voltage spike, caused by an alpha particle or by cosmic radiation, will falsify a logic value in an integrated circuit. The effect can be a false calculation result. In safety-related systems, such errors must therefore be detected reliably.

In safety-related systems, such as an ABS control system in a motor vehicle, in which malfunctions of the electronic equipment must be detected with certainty, redundancies for error detection are normally provided particularly in the corresponding control devices of such systems. Thus, for example, in conventional ABS systems, the complete microcontroller is duplicated in each instance, all ABS functions being calculated redundantly and checked for consistency. If a discrepancy appears in the results, the ABS system is switched off.

Such processor units having at least two integrated execution units are also referred to as dual-core architectures or multi-core architectures. The different execution units (cores) execute the same program segment redundantly and in a clock-synchronized manner; the results of the two execution units are compared, and an error will then be detected in the comparison for consistency.

Processors are equipped with caches to accelerate access to instructions and data. This is necessary in light of the ever-increasing volume of data, on the one hand, and in light of the increasing complexity of data processing using processors that operate at faster and faster speeds, on the other hand. A cache may be used to avoid to some extent the slow access to a large (main) memory, and the processor consequently does not have to wait for data to be provided. Both caches exclusively for instructions and caches exclusively for data are conventional, but also “unified caches,” in which both data and instructions are stored in the same cache. Systems having multiple levels (hierarchy levels) of caches are also conventional. Such multi-level caches are used to perform an optimal adjustment of the speeds between the processor and the (main) memory by using graduated memory sizes and various addressing strategies of the caches on the different levels.

Caches are also used to avoid conflicts in accessing the system bus or memory bus in a multiprocessor system. In a multiprocessor system it is common to equip every processor with a cache, or in the case of multi-level caches with correspondingly more caches.

In one conventional arrangement of caches in a switchable dual-core system, each of the two cores has one permanently assigned cache that the core accesses in the performance mode. In the compare mode, both cores access their respective cache. In addition to the fact that in the compare mode a datum is stored multiple times in the cache (separately for each execution unit), in particular the time required for a change from the performance mode to the compare mode is considerable.

During this change, the state of the caches must be adapted. Only this ensures that in the compare mode a case in which one of the execution units involved in the comparison has a cache miss (requested datum is not stored in the cache and must be reloaded) and another a cache hit (requested datum is stored in the cache and does not need to be reloaded) does not arise.

### SUMMARY

Example embodiments of the present invention, in a multiprocessor system, avoid the disadvantages of conventional methods when using caches in a switchable multiprocessor system. A disadvantage in this context is that in conventional arrangements of caches, the caches must be synchronized in a costly way when a switchover from a performance mode to a compare mode occurs.

For the switchover option between different modes of a multiprocessor system, such as the performance and the compare mode, it is advantageous if not every execution unit has its own cache, since in particular during the switchover to the compare mode a time-consuming adaptation of the cache would have to be carried out. This may be avoided to a great extent in the provided structures.

In addition, it is advantageous if the sizes of the different caches for the different modes (compare or performance) can be adjusted to the requirements of the modes. Furthermore, it may be advantageous that in some modes the cache is dispensed with altogether, in particular if the bus access itself is not significantly slower than a cache access.

A method for controlling memory access in a computer system having at least two execution units is described, a buffer, in particular a cache being provided for each execution unit, and furthermore a switchover device and a comparison device being provided, the system switching between a performance mode and a compare mode, wherein in the performance mode each execution unit accesses the buffer assigned to it and in the compare mode both execution units access one buffer.

A method is described, wherein the buffer that is accessed by both execution units in the compare mode corresponds to the buffer of one execution unit.

A method is described, wherein at least one additional buffer, in particular an additional cache, is provided, and in the compare mode both execution units access this additional buffer.

A method is described, wherein at least one additional buffer is provided and the buffer that is accessed by both execution units in the compare mode is made up of the additional buffer and a buffer of an execution unit.

A method is described, wherein in the compare mode only read access is permitted to the memory assigned to an execution unit.

A method is described, wherein in the compare mode the comparison device compares information for consistency and in the event of deviation, an error is detected, and where an error occurs, an access to the buffer is prevented.

A method is described, wherein in the compare mode the comparison device compares information for consistency and in the event of deviation, an error is detected, and where an error occurs, information in the buffer is invalidated or blocked.

A method is described, wherein in the compare mode the comparison device compares information for consistency and in the event of deviation an error is detected, and where an error occurs, the computer system is started anew or restarted.

A method is described, wherein in the compare mode the comparison device compares information for consistency and in the event of deviation an error is detected, and where an error occurs, at least one execution unit is started anew or restarted.

A device for controlling a memory access in a computer system having at least two execution units is advantageously included, a buffer, in particular a cache being provided for each execution unit, and furthermore a switchover device and a comparison device being provided, the system switching between a performance mode and a compare mode, wherein a device is included that is designed such that in the performance mode each execution unit accesses the buffer assigned to it and in the compare mode both execution units access one buffer.

A device is advantageously included, wherein the buffer that is accessed by both execution units in the compare mode corresponds to the buffer of one execution unit.

A device is advantageously included wherein at least one additional buffer, in particular an additional cache, is provided, and in the compare mode both execution units access this additional buffer.

A device is advantageously included, wherein at least one additional buffer is provided and the buffer that is accessed by both execution units in the compare mode is made up of the additional buffer and a buffer of an execution unit.

A device is advantageously included, wherein the device is designed such that in the compare mode only read access is permitted to the memory assigned to an execution unit.

A device is advantageously included, wherein the comparison device is designed such that it compares information for consistency in the compare mode and, in the event of a deviation, detects an error, and when an error occurs, prevents access to the buffer.

A device is advantageously included, wherein the comparison device is designed such that it compares information for consistency in the compare mode and, in the event of a deviation, detects an error, and when an error occurs, invalidates or blocks information in the buffer.

A device is advantageously included, wherein the comparison device is located between at least one execution unit and the buffers.

A device is advantageously included, wherein the buffers are located between at least one execution unit and the comparison device.

A device is advantageously included, wherein the switchover device and the comparison device are implemented as a switchover and comparator unit.

Other features and aspects of example embodiments are described below with reference to the appended Figures.

### BRIEF DESCRIPTION OF THE DRAWINGS

FIG. 1 shows a system C100 having two execution units, only one of which accesses a bus C10 via a cache in the performance and compare mode.

FIG. 2 shows a system C100c having two execution units, both of which access bus C10 via a cache in the performance and compare mode, only one of which, however, is used in the compare mode.

FIG. 3 shows a system C100a having two execution units, only one of which accesses bus C10 via a cache in the performance mode. No cache is used in the compare mode.

FIG. 4 shows a system C200 having two execution units, both of which access bus C10 via a cache in the performance and compare mode. In the compare mode, access to the bus occurs via a separate bus interface unit.

FIG. 5 shows a system C200a having two execution units, both of which access bus C10 via a cache in the performance and compare mode. In the compare mode, access to the bus occurs via a separate cache and a separate bus interface unit.

FIG. 6 shows a system C300 having two execution units, both of which access bus C10 via a cache in the performance and compare mode, only one of which, however, is used in the compare mode. The cache used in the compare mode uses internally different memories for its task, as a function of the current mode of system C300.

FIG. 7 shows a system C400 having two execution units, both of which access bus C10 via a cache in the performance and compare mode, only one of which, however, is used in the compare mode. The cache used in the compare mode uses internally different memories for its task, as a function of the current mode of system C400. The relative sizes of these two memories to each other is controlled by a separate unit.

FIG. 8 shows a system C500 having two execution units that access bus C10 via a cache unit. Depending on the mode of system C500, the memory accesses of the execution units are served differently.

### DETAILED DESCRIPTION

In the following, an execution unit may denote both a processor/core/CPU, as well as an FPU (floating point unit), a DSP (digital signal processor), a co-processor or an ALU (arithmetic logical unit).

In some multiprocessor systems a cache is used only to avoid conflicts in the system bus and/or memory bus. If only one execution unit existed, then in this case no cache would be necessary since the memory is fast enough to serve the read requests of one execution unit.

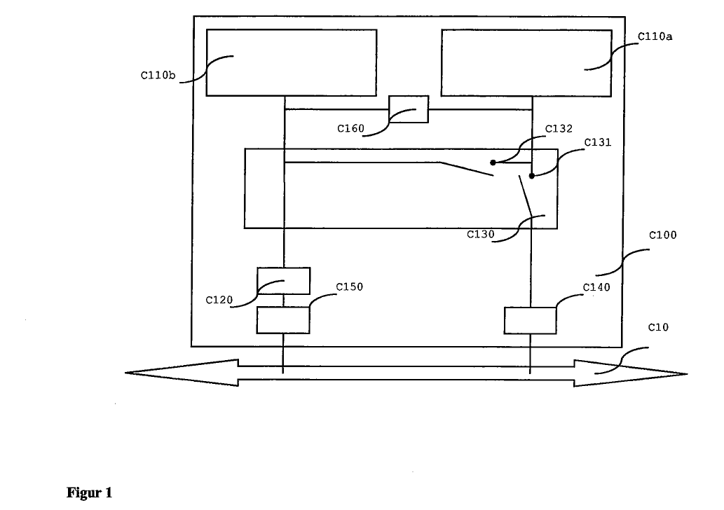

FIG. 1 shows a first variant of a multiprocessor system C100 having two execution units C110a and C110b that may access a memory via a bus C10. A unit C130 controls, depending on the mode of system C100, how bus C10 is accessed. In the performance mode, a switch C131 is closed and a switch C132 open. Thus, execution unit C110b accesses bus C10 via a cache C120 and a bus interface C150. Execution unit C110a is connected directly to bus C10 via a connection C140. If cache C120 is dimensioned correctly, then memory accesses of execution unit C110b are served primarily from C120 so that an access to bus C10 is only rarely necessary. The memory accesses of the execution unit C110a always result in accesses to the bus C10. The bus is accessed via unit C150 only when a memory access cannot be served via cache C120. If execution unit C110a accesses bus C10 at the same time via C140, a bus conflict occurs that must be resolved by the bus protocol. Since cache C120 is not visible to the software, it is advantageous if unit C120 listens in on bus C10 (“bus snooping”) to see whether execution unit C110a is modifying via C140 a datum in the memory that is also located in cache C120. If this is the case, the relevant datum in C120 must be replaced by the new datum or be marked as invalid.

In the compare mode, switch C132 is closed and switch C131 open. Both execution units jointly access bus C10 via cache C120. A comparator unit C160 compares the output signals of both execution units and generates an error signal in the event of differences. Optionally, comparator unit C160 may be connected to bus interface unit C150 (not shown here) and prevent a write access if the output signals of the two cores differ. In the performance mode, unit C160 is deactivated. The deactivation of the comparator unit may be achieved in different manners: Either a comparison by unit C160 is not carried out; no signals for comparison are applied to unit C160; or although the comparison takes place, the result is ignored.

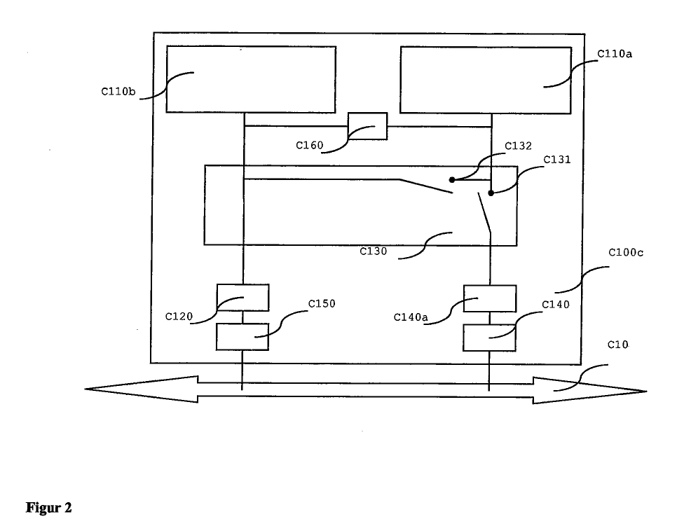

An example embodiment of the present invention is shown in FIG. 2 by a system C100c. In this example embodiment, the elements from FIG. 1 work in the same manner. However, in the performance mode, having a closed switch C131, execution unit C100a accesses bus C10 likewise via cache C140a and bus interface C140. In the compare mode, both execution units C110a and C110b use cache C120 via the then closed switch C132, while C110a uses C140a only in the performance mode. Both caches C120 and C140a may have different sizes and be accordingly optimized for the tasks adjusted in the different modes.

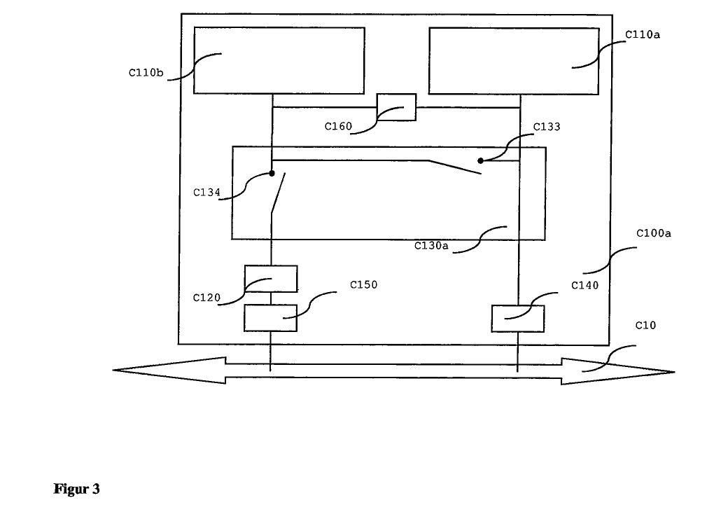

FIG. 3 shows a further example embodiment of the present invention. In this instance, C100a designates a multiprocessor system. Here, the switch C133 is open in the performance mode and the switch C134 is closed, and an execution unit C110b accesses the bus C10 via a cache C120 and the bus interface unit C150. The other execution unit C110a accesses bus C10 directly via unit C140. In the compare mode, by contrast, switch C133 is closed and C134 is open; both execution units access bus C10 directly via C140, and cache C120 is not used. A comparator unit C160 compares the output signals of both execution units and generates an error signal in the event of differences. Optionally, here too comparator unit C160 may be connected to bus interface units C140 (not shown here) and prevent a write access if the output signals of the two execution units differ. In the performance mode, unit C160 is deactivated. The deactivation may be implemented in different ways, which have already been described.

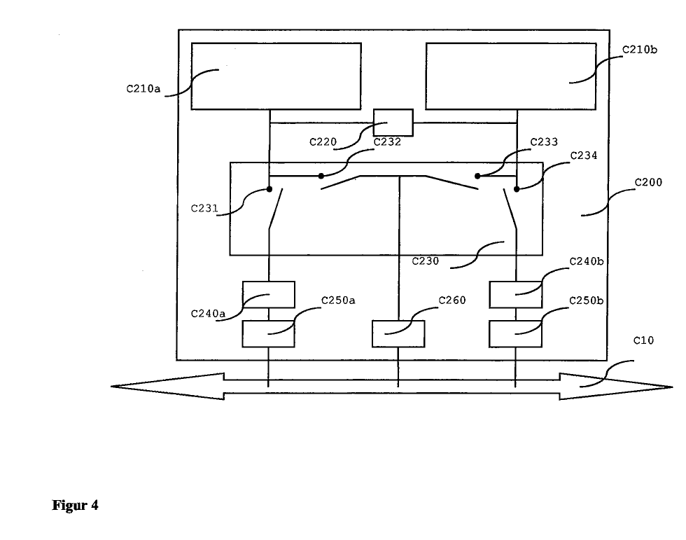

In an additional variant of the multiprocessor system, caches are also used only for avoiding conflicts in access to the memory bus. FIG. 4 shows a multiprocessor system C200 having two execution units C210a and C210b that, in different manners, may access a memory via bus C10. A unit C230 controls, depending on the mode of system C200, how bus C10 is accessed. In the performance mode, switches C231 and C234 are closed and switches C232 and C233 are open. Thus, execution unit C210a accesses bus C10 via a cache 240a using a bus interface C250a, and execution unit C210b via a cache C240b using a bus interface C250b. An access to bus C10 is required only if the memory accesses cannot be served by the respective caches of the execution units. If other execution units access bus C10 at the same time, a bus conflict occurs that must be resolved by the bus protocol. Since caches C240a and C240b are not visible to the software, it is advantageous if a datum that is written by one execution unit C210a, C210b to the respective cache C240a, C240b is likewise written immediately to the memory via the respective bus interface C250a, C250b to bus C10 (“write-through” strategy).

Furthermore, it is advantageous if units C240a and C240b listen in on bus C10 (“bus snooping”) (via C250a and C250b respectively) to see whether execution unit C210a via C250a or C210b via C250b modifies a datum in the memory that is also located in the cache of the other. If this is the case, the relevant datum in the affected cache must be replaced by the new datum or be marked as invalid.

In the compare mode, switches C232 and C233 are closed and switches C231 and C234 are open. Both execution units jointly access bus C10 via a cache C260. The caches (C240a, C240b) are not used. A comparator unit C220 compares the output signals of both execution units and generates an error signal in the event of differences. Optionally, comparator unit C220 may be connected to a bus interface unit C260 (not shown here) and prevent a write access if the output signals of the two execution units differ. In the performance mode, unit C220 is deactivated. The deactivation may be implemented in different manners, which have already been described.

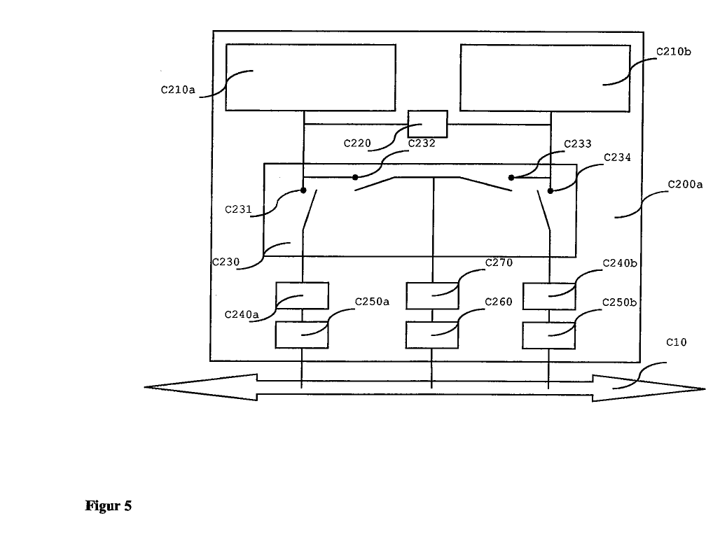

FIG. 5 shows an additional example embodiment C200a of the multiprocessor system, in which example embodiment in contrast to the example embodiment C200, shown in FIG. 4, an additional cache 270 has been inserted for the compare mode. The components from FIG. 4 work in the same manner, as described above. In this system too, it is advantageous if a “write-through” strategy is used for all caches, and the consistency of the content of all caches is maintained through “bus snooping.”

The previously described variants according to FIGS. 4 and 5 may be extended to more than two execution units. In this case, one cache unit and one bus interface unit exist for each execution unit and are used in the performance mode. In the compare mode, all execution units access bus C10 via bus interface unit C260 (optionally using a cache C270).

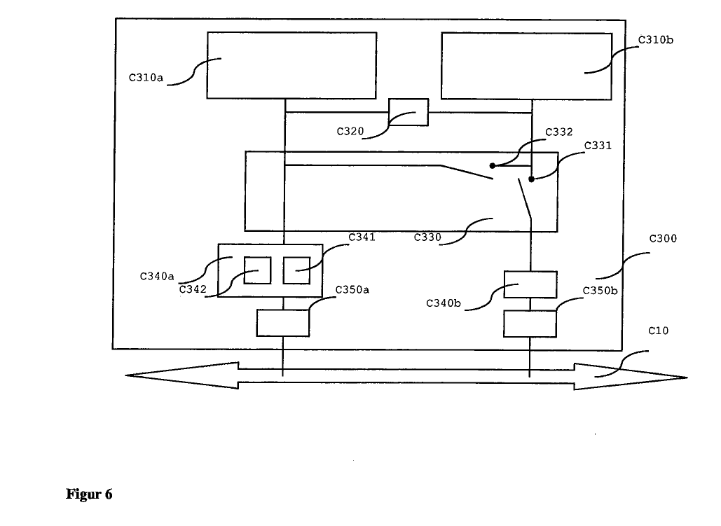

An additional example embodiment of the present invention is shown in FIG. 6. Here too, processor unit C300 is made up of at least two execution units C310a and C310b which each access a memory via a cache C340a, 340b and a bus interface C350a, C350b via bus C10. In the performance mode, a switch C332 is open and a switch C331 is closed in unit C330. In this configuration, execution unit C310a accesses bus C10 via cache C340a and bus interface C350a, and execution unit C310b via cache C340b and bus interface C350b.

In the compare mode, switch C330 is closed and switch C332 open in switchover unit C331. Now both execution units access bus C10 via cache C340a and bus interface C350a. Unit C340a itself is in turn made up of two separate cache memories or cache areas C341, C342 that are used for the caching. In the performance mode, only memory/area C341 is used, while in compare mode memory/area C342 is used for caching in addition to memory/area C341. In the compare mode, a comparator unit C320 compares the output signals of both execution units and generates an error signal in the event of differences. Optionally, here too comparator unit C320 may be connected to bus interface units C350a (not shown here) and prevent a write access if the output signals of the two cores differ in the compare mode. In the performance mode, compare unit C320 is deactivated, as was already described for comparator unit C160, shown in FIG. 1.

In an additional example embodiment, unit C340a may be constructed such that in the compare mode memory C341 and C342 are in fact used in conjunction as well, but only contents from memory C342 may be removed and replaced by other contents in the compare mode.

All example embodiments in the refinement of FIG. 6 may be extended to more than two execution units. In this case, one cache unit and one bus interface unit exist for each execution unit and are used in the performance mode. In the compare mode, all execution units access bus C10 via cache C340a and bus interface unit C350a.

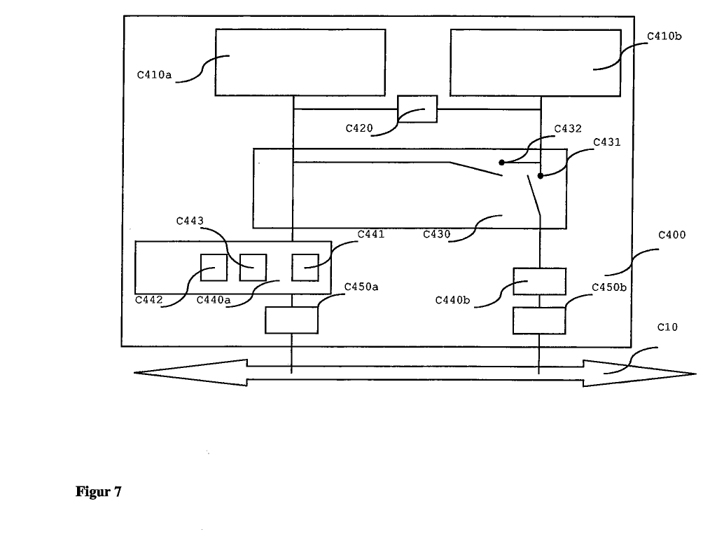

An additional possible example embodiment of the present invention is shown in FIG. 7. Here too, the processor unit C400 is made up of at least two execution units C410a and C410b, which each access a memory via a cache (C440a, 440b) and a bus interface (C450a, C450b) to the bus 010.

In the performance mode, a switch C432 is open and a switch C431 is closed in unit C430. In this configuration, execution unit C410a accesses bus C10 via cache C440a and bus interface C450a, and execution unit C410b via cache C440b and bus interface C450b.

In the compare mode, switch C432 is closed and switch C431 open in switchover unit C430. Now both execution units access bus C10 via cache C440a and bus interface C450a. The unit C440a itself is in turn made up of two separate cache memories or areas C441, C442 that are used for the caching. In the performance mode, only memory/area C441 is used, while in the compare mode memory/area C442 is used for caching. The sum of the sizes of both memories/areas C441+C442 is constant, but the ratio between the sizes of C441 and C442 is controlled by a unit C443. Through this unit C443, it is possible to modify the ratio during operation.

In the compare mode, a comparator unit C420 compares the output signals of both execution units and generates an error signal in the event of differences. Optionally, here too the comparator unit C420 can be connected to the bus interface units C450a (not shown here) and prevent a write access if the output signals of the two execution units differ in the compare mode. In the performance mode, unit C420 is deactivated, as was described for comparator unit C160 from FIG. 1.

Unit C440a may now be executed as follows while maintaining the function of unit C443:
1. In the compare mode, both memories C441 and C442 are used for the cache.
2. In the compare mode, both memories C441 and C442 are used for the cache; however, only contents for memory C442 being able to be removed in the compare mode and replaced by other contents.

All example embodiments in the refinement of FIG. 7 may be extended to more than two execution units. In this case, one cache unit and one bus interface unit exist for each execution unit and are used in the performance mode. In the compare mode, all execution units access bus C10 via cache C440a and bus interface C450a.

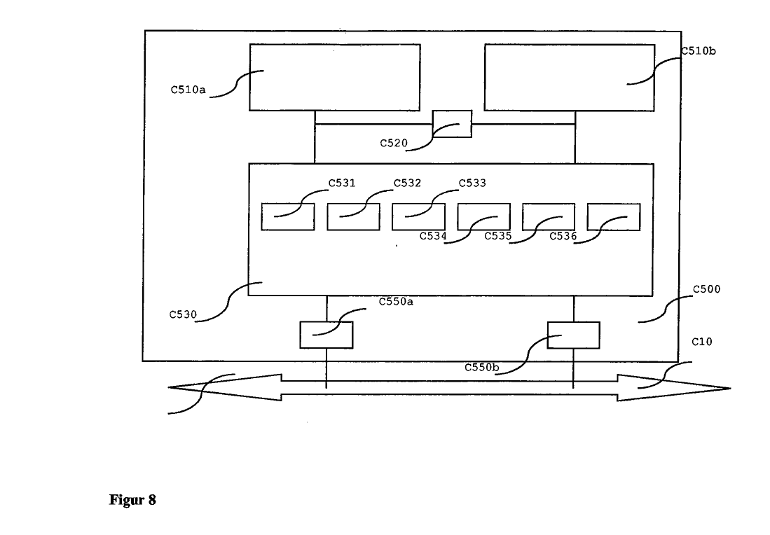

FIG. 8 depicts a further example embodiment. At least two execution units C510a and C510b exist in a processor system C500. Both execution units are connected to a cache unit C530. This unit C530 has one bus interface unit C550a, C550b for each execution unit, via which an access to a memory via bus C10 is possible. Cache unit C530 has two cache memories (here C531 and C533 for C510a, and C534 and C536 for C510b) for each connected execution unit. The sum of the sizes of these memory pairs is constant; during operation, however, the ratio may be changed via one unit in each instance (C532 for C531, C533 and C535 for C534, C536).

In the performance mode, memory accesses by the execution units are always cached by the memory pair that is assigned to the execution unit. In the process, only one of the two cache memories is used (here C531 for C510a, and C534 for C510b). If memory accesses by the execution unit cannot be served from the cache memory, the necessary bus accesses to C10 are always done via the bus interface assigned to the execution unit (here C550a for C510a, and C550b for C510b). In the performance mode, simultaneous accesses by execution units may also be served simultaneously via unit C530, unless a bus conflict occurs due to the simultaneous access to C10.

In the compare mode, the memory accesses by the execution units are served by the cache memories that are not used in the performance mode (here C533 and 536). Any bus interface may be used for a bus access. In the compare mode, a comparator unit C520 compares the output signals of all execution units and generates an error signal in the event of differences. Optionally, here too comparator unit C520 may be connected to bus interface units C550a, C550b (not shown here) and prevent a write access if the output signals of the two cores differ in the compare mode. In the performance mode, unit C520 is deactivated. It may be deactivated accordingly as in the comparator unit C160 from FIG. 1.

In an additional example embodiment, unit C530 may be structured such that in the compare mode all cache memories (here C531, C533, C534, C536) are used, but only the cache memory contents that are not used in the performance mode are discarded and replaced.

For all implementations shown here by way of example, the switchover and comparator unit is always situated between the execution units and their associated caches. If a cache is used in the compare mode, this cache must be safeguarded by ECC or parity so that errors are detected in this instance also. Additionally, it is advantageous if a “write-through” strategy is used for the caches, and the consistency of the content of the caches is maintained through “bus snooping.”

1-19. (canceled)

20. A method for controlling a memory access in a computer system having at least two execution units, at least one of (a) a buffer and (b) a cache for each execution unit, a switchover device, and a comparison device, comprising:
performing a switchover between a performance mode and a compare mode;
wherein in the performance mode each execution unit accesses the buffer assigned to it and in the compare mode both execution units access one buffer.

21. The method according to claim 20, wherein the buffer that is accessed by both execution units in the compare mode corresponds to the buffer of one execution unit.

22. The method according to claim 20, wherein at least of (a) at least one additional buffer and (b) at least one additional cache is provided, and in the compare mode both execution units access the additional buffer.

23. The method according to claim 20, wherein at least one additional buffer is provided and the buffer that is accessed by both execution units in the compare mode is made up of the additional buffer and a buffer of an execution unit.

24. The method according to claim 23, wherein in the compare mode only read access is permitted to a memory assigned to an execution unit.

25. The method according to claim 20, wherein in the compare mode the comparison device compares information for consistency and in the event of deviation, an error is detected, and where an error occurs, an access to the buffer is prevented.

26. The method according to claim 20, wherein in the compare mode the comparison device compares information for consistency and in the event of deviation, an error is detected, and where an error occurs, information in the buffer is at least one of (a) invalidated and (b) blocked.

27. The method according to claim 20, wherein in the compare mode the comparison device compares information for consistency and in the event of deviation an error is detected, and where an error occurs, the computer system is at least one of (a) started anew and (b) restarted.

28. The method according to claim 20, wherein in the compare mode the comparison device compares information for consistency and in the event of deviation an error is detected, and where an error occurs at least one execution unit is at least one of (a) started anew and (b) restarted.

29. A device for controlling a memory access in a computer system, comprising:
at least two execution units;
at least one of (a) a buffer and (b) a cache for each execution unit;
a switchover device configured to perform a switchover between a performance mode and a compare mode;
a comparison device; and
an arrangement configured such that in the performance mode each execution unit accesses the buffer assigned to it and in the compare mode both execution units access one buffer.

30. The device according to claim 29, wherein the buffer that is accessed by both execution units in the compare mode corresponds to the buffer of one execution unit.

31. The device according to claim 29, wherein at least one of (a) at least one additional buffer and (b) at least one additional cache is provided, and in the compare mode both execution units access the additional buffer.

32. The device according to claim 29, wherein at least one additional buffer is provided and the buffer that is accessed by both execution units in the compare mode is made up of the additional buffer and a buffer of an execution unit.

33. The device according to claim 32, wherein the device is configured such that in the compare mode only read access is permitted to a memory assigned to an execution unit.

34. The device according to claim 29, wherein the comparison device is configured to compare information for consistency in the compare mode and, in the event of a deviation, to detect an error, and when an error occurs, to prevent access to the buffer.

35. The device according to claim 29, wherein the comparison device is configured to compare information for consistency in the compare mode and, in the event of a deviation, to detect an error, and when an error occurs, to at least one of (a) invalidate and (b) block information in the buffer.

36. The device according to claim 29, wherein the comparison device is located between at least one execution unit and the buffers.

37. The device according to claim 29, wherein the buffers are located between at least one execution unit and the comparison device.

38. The device according to claim 29, wherein the switchover device and the comparison device are arranged as a switchover and comparator unit.
